(19) United States
(12) Patent Application Publication
(10) Pub. No.: US 2012/0115349 A1
(43) Pub. Date: May 10, 2012

(54) DEVICE FOR MAINTAINING A PLUG AND SOCKET CONNECTION BETWEEN TWO ELECTRICAL CORDS

(76) Inventor: Richard Martin Kierstead, Vancouver (CA)

(21) Appl. No.: 12/943,707

(22) Filed: Nov. 10, 2010

(51) Int. Cl. H01R 13/62

(52) U.S. Cl. 439/369

(57) ABSTRACT

The present invention relates to a device used to maintain a plug and socket connection between two electrical cords. The device includes a pair of spaced-apart frustoconical members. Each frustoconical member has a passageway for receiving one of the cords and has a tapered exterior surface. Each frustoconical member has a pair of sides configured to guide the cord to its central passageway. The sides are angularly spaced-apart with respect to each other by an angle between 90 and 120 degrees, forming a channel therebetween. Each frustoconical member further has a pair of opposed recesses, between the inner and outer ends, with a space therebetween to facilitate insertion of its cord. Two elastic connecting members connect together the inner ends of the frustoconical members. The connecting members stretch over the plug and socket and bias the inner ends of the frustoconical members against outer ends of the plug and socket.

### FIELD OF THE INVENTION

This invention relates to devices used to prevent accidental disconnection of electrical plug and socket connections attached to conductor cords. It also relates to preventing deflection of electrical plug and socket connections, as well snagging and the like, when cords are being pulled or dragged, such as when working with power tools.

### DESCRIPTION OF THE RELATED ART

Tradespeople working on home improvements and home maintenance commonly use power tools plugged into electrical extension cords for many purposes. When being pulled or dragged, the electrical plug and socket connection regularly comes apart, snags or both. Electrical cords are sometimes tied into knots to prevent such disconnections, but this causes strain on the cords and increases snagging.

It is known to provide a device for maintaining a plug and socket connection having a pair of spaced-apart end portions connected together by elongate flat elastic bands, where each end portion has a slit for receiving a respective cord and where the end portions stretch over the plug and socket connection. For example, please see the device shown in U.S. Pat. No. 5,713,753 to Bayer or U.S. Pat. No. 5,443,397 to Carl. However, such slits may be difficult to open and, as a result, it may be difficult to insert the cords. This problem is exacerbated when a user needs to switch between a variety of power tools during the course of the day, discouraging a user from using such devices. In order to facilitate the opening of the slits, a high degree of elasticity in the end portion material may be required; however, such a high degree of elasticity may reduce the ability of the device to hold the cords together.

Also, protruding parts, such as flanges 72 and 74 in the device shown in Carl, may inhibit the device's deflective capability, rending the device more prone to snagging of the device on sharp corners, edges and the like. This not only may be extremely irritating but can be very dangerous. If for instance the user were operating a large router with a large digging bit and the device snagged, the resulting uneven pressures can cause the router to jump wildly. This in turn can cause damage to the material being worked on and possibly also cause serious injury to the operator of the router.

The elongate flat nature of the elastic bands of the known prior art may also cause the bands to prematurely tear due to the difficulty in molding uniform bands in such a shape. After molding the exterior of the bands will typically cool faster than the interior of the bands. As a result, the bands may exhibit non-uniform elasticity, which in turn may promote failure.

### BRIEF SUMMARY OF INVENTION

The present invention as disclosed herein provides a device for maintaining a plug and socket connection between two electrical cords that overcomes the above disadvantages. It is an object of the present invention to provide an improved device for maintaining a plug and socket connection between two electrical cords.

There is accordingly provided a device used to maintain a plug and socket connection between two electrical cords. The device includes a pair of spaced-apart frustoconical members. Each frustoconical member is in the shape of a truncated, partial cone. Each frustoconical member has an inner end and an outer end spaced-apart from the inner end. Each outer end is smaller in cross-section relative to its corresponding inner end. Each frustoconical member has a tapered exterior surface that extends between its inner end and its outer end. Each frustoconical member has a central passageway for receiving a corresponding one of the cords. The passageways extend from their corresponding inner ends to their corresponding outer ends, respectively. Each frustoconical member has a pair of sides configured for guiding said one of the cords to its central passageway. Each of the sides extends from the tapered exterior surface to the central passageway. The sides are angularly spaced-apart with respect to each other by an angle between 90 and 120 degrees, forming a channel therebetween. The device includes a pair of elastic connecting members extending from and being disposed between the inner ends of the frustoconical members. The connecting members are configured to stretch over the plug and socket and bias the inner ends of the frustoconical members against outer ends of the plug and socket. The device thereby maintains the plug and socket connection.

There is also provided a device used to maintain a plug and socket connection between two electrical cords. The device includes a pair of spaced-apart frustoconical members. Each frustoconical member has an inner end and an outer end spaced-apart from the inner end. The outer ends are smaller in cross-section relative to the inner ends. Each frustoconical member has a tapered exterior surface that extends between its inner end and its outer end. Each frustoconical member has a central passageway for receiving a corresponding one of the cords. The passageways extend from the inner ends to the outer ends, respectively. Each frustoconical member has a longitudinal channel configured for guiding said one of the cords to its corresponding central passageway. The longitudinal channels extend from the tapered exterior surfaces to the central passageways. Each frustoconical member includes a pair of spaced-apart, opposed inner walls defining a space therebetween to facilitate insertion of the cord into its central passageway. Each pair of inner walls extends between the corresponding inner end and the corresponding outer end, extending from a respective side of its central passageway to the channel and being spaced-apart from each other at a distance equal to or greater than the cross-sectional diameter of the passageway. The device includes a pair of elastic connecting members extending from and disposed between the inner ends of the frustoconical members. The connecting members are configured to stretch over the plug and socket, thereby biasing the inner ends of the frustoconical members against outer ends of the plug and socket for maintaining the plug and socket connection.

According to another aspect, there is provided a device used to maintain a plug and socket connection between two electrical cords. The device is made of an elastic material. The device includes a pair of spaced-apart frustoconical members. Each frustoconical member is in the shape of a truncated, partial cone. Each frustoconical member has an inner end. Each inner end includes a bevelled peripheral portion disposed to face at least partially outwards from the device. Each bevelled peripheral portion is configured to inhibit its inner end from getting caught on objects. Each frustoconical member has an outer end spaced-apart from its corresponding inner end. The outer ends are smaller in cross-section relative to the inner ends. The outer ends are relatively flexible compared to the inner ends to accommodate bending and deflection of portions of the cords adjacent thereto. Each frustoconical member has a tapered exterior surface that extends between its inner end and its outer end. Each frustoconical member has a central passageway for receiving a corresponding one of the cords. Each passageway extends from its corresponding inner end to its corresponding outer end. Each frustoconical member has a longitudinal channel configured for guiding said one of the cords to the central passageway. The channels are quadrant-shaped in cross-section. Each frustoconical member has a pair of spaced-apart, opposed recesses and inner walls configured for facilitating disposal of an initial portion of the cord into its central passageway. Each pair of recesses is disposed between the inner end and the outer end, is in communication with opposite sides of the central passageway, and at least partially extends through portions of the frustoconical member surrounding the channel. Each recess is in the shape of a triangular prism. Each inner wall is adjacent to a respective one of the recesses and tangentially extends from the central passageway to the channel. The device includes a pair of elastic connecting members extending from and being disposed between the bevelled peripheral portions of the inner ends of the frustoconical members. The connecting members are round in cross-section and the bevelled peripheral portions are disposed to facilitate outward stretching of the connecting members. The connecting members are configured to stretch over the plug and socket, thereby biasing the inner ends of the frustoconical members against outer ends of the plug and socket for maintaining the plug and socket connection.

The device as herein described may be referred to as a plug harness.

### BRIEF DESCRIPTION OF DRAWINGS

The invention will be more readily understood from the following description of preferred embodiments thereof given, by way of example only, with reference to the accompanying drawings, in which:

FIG. 1 is a top view of a plug harness attached to two electrical cords and a plug and socket connection, the plug harness having two spaced-apart frustoconical members, according to one embodiment, connected together with a pair of elastic connecting members, the plug and socket connection being disposed therebetween;

FIG. 2 is an end elevation view of the plug harness shown in FIG. 1;

FIG. 3 is a sectional view along lines 3-3 of FIG. 1;

FIG. 4 is a bottom plan view of a plug harness according to another embodiment;

FIG. 5 is a side elevation view of the plug harness shown in FIG. 4, with the bottom of the plug harness facing up from the perspective of the figure;

FIG. 6 is a top plan view of the plug harness shown in FIG. 4;

FIG. 7 is a side elevation view of the side opposite FIG. 5, with the top side of the plug harness facing up from the perspective of the figure;

FIG. 8 is an end view of the plug harness shown in FIG. 5; and

FIG. 9 is a sectional view along lines 9-9 of FIG. 6.

### DESCRIPTION OF THE PREFERRED EMBODIMENTS

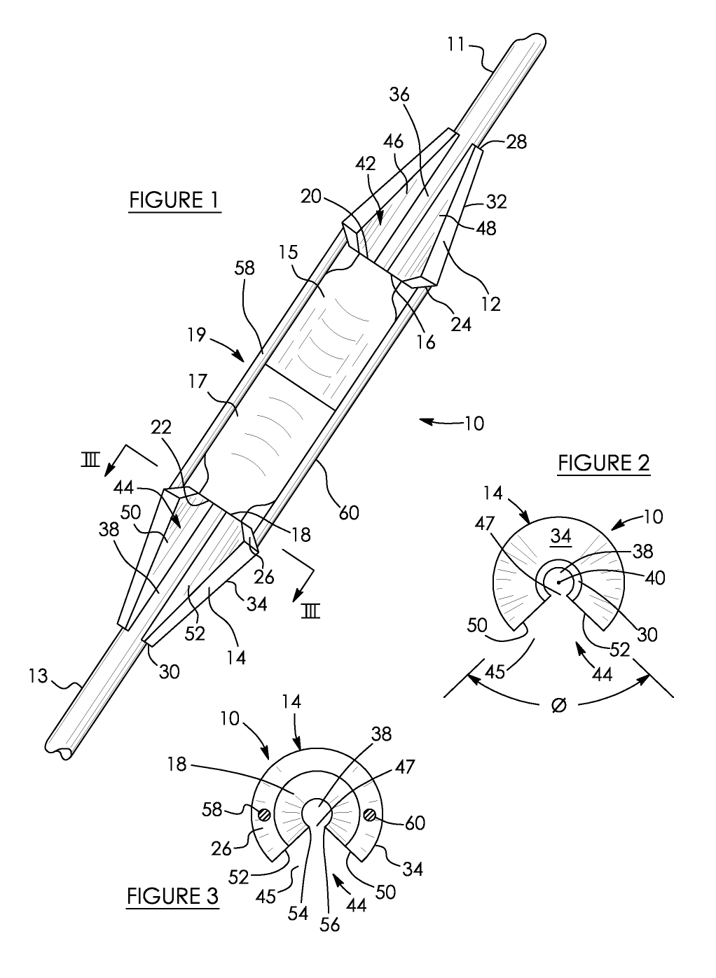

Referring to the drawings and first to FIG. 1, the present application is directed to a plug harness 10. The plug harness is made of a flexible elastic material, such as plastic, and in this example is specifically made of polyurethane though it could be made of other elastic materials. The plug harness in this example is a one-piece device made via a multiple part injection type mold though it could be assembled from multiple parts.

The plug harness 10 includes a pair of frustoconical members 12 and 14. Frustoconical members 12 and 14 have substantially identical configurations and function. The frustoconical members are configured to snap onto electrical cords 11 and 13, which have a plug 15 and a socket 17 connected together via a plug and socket connection 19.

Each of the frustoconical members 12 and 14 is in the shape of a truncated, partial cone. Frustoconical members 12 and 14 have inner ends 16 and 18 configured to face one another. Inner ends 16 and 18 are shaped to abut the exterior ends or shoulders 20 and 22 of the plug 15 and socket 17, respectively. Inner ends 16 and 18 of the frustoconical members include bevelled peripheral portions 24 and 26. The bevelled peripheral portions are partially annular in shape, as seen for portion 26 in FIG. 3, are disposed to face each other and are also disposed to face at least partially outwards with respect to the plug harness 10. The bevelled peripheral portions 24 and 26 so shaped, advantageously, inhibit the inner ends 16 and 18 of the frustoconical members from getting caught on corners, sharp edges and the like.

The frustoconical members 12 and 14 have outer ends 28 and 30 spaced-apart from the inner ends 16 and 18. The outer ends 28 and 30 face away from each other and are smaller in cross-section relative to the inner ends 16 and 18 of the frustoconical members. The tapered and conical nature of the frustoconical members 12 and 14, with its relatively small outer ends, enables the plug harness to readily deflect around and over corners and snags when pulled or dragged.

Also, the outer ends so shaped are relatively flexible compared to the inner ends since they are thinner. Thus, the outer ends are configured to accommodate bending and deflections of portions of the cords 11 and 13 adjacent thereto while the plug harness 10, with its inner ends 16 and 18, maintains the plug and socket connection 19.

The frustoconical members 12 and 14 have tapered exterior surfaces 32 and 34 as best shown by tapered exterior surface 34 in FIG. 2. In this example exterior surfaces 32 and 34 may have a morse taper. Tapered exterior surface 32 extends between bevelled peripheral portion 24 of inner end 16 and outer end 28. Tapered exterior surface 34 extends between bevelled peripheral portion 26 of inner end 18 and outer end 30. Surface 32 is straight in the direction extending from bevelled peripheral portion 24 to outer end 28, and surface 34 is straight in the direction extending from bevelled peripheral portion 26 to outer end 30. The surfaces 32 and 34 may thus be described as having a straight taper. The tapered exterior surfaces 32 and 34 have the shape of a partial cone.

The frustoconical members 12 and 14 include longitudinally extending central passageways 36 and 38 for receiving the cords 11 and 13. Passageways 36 and 38 are generally circular in cross-section, or put another way, partially cylindrical, and are shaped to receive the cords 11 and 13, respectively, shown in FIG. 1. They have a diameter equal to or slightly smaller than the cord in this example. Passageways 36 and 38 extend along and align with central axis 40 of the frustoconical members, as shown in FIG. 2. Passageway 36 extends from inner end 16 to outer end 28 and passageway 38 extends from inner end 18 to outer end 30.

The frustoconical members 12 and 14 include longitudinal channels 42 and 44 configured for readily guiding the cords 11 and 13 to central passageways 36 and 38. Channel 42 extends from inner end 16 to outer end 28 and channel 44 extends from inner end 18 to outer end 30. In this preferred embodiment, the channels are quadrant-shaped in cross-section, as shown in FIGS. 2 and 3 for channel 44.

The channels 42 and 44 include outer regions or outer openings, as shown by outer opening 45 in FIGS. 2 and 3. The outer openings are much larger than the cross-sectional diameters of cords 13 and 15 and are larger than the cross-sectional diameter of the central passageways. Channels 42 and 44 include inner regions or inner openings, as shown by inner opening 47 in FIGS. 2 and 3, which are adjacent to the central passageways. The inner openings are smaller than the cross-sectional diameters of the cord 13 and 15 and smaller than the cross-sectional diameter of the central passageways. The channels render the passageways more exposed for receiving the cords.

Frustoconical member 12 has a pair of spaced-apart sides 46 and 48, each of which extends from tapered exterior surface 32 to central passageway 36. Likewise frustoconical member 14 has a pair of spaced-apart sides 50 and 52 that extend from tapered exterior surface 34 to central passageway 38. Sides 46, 48, 50 and 52 are generally triangular in shape in this example as seen in FIG. 1. Sides 46, 48, 50 and 52 are adjacent to and face channels 42 and 44, respectively. Sides 46 and 50 are angularly spaced-apart from sides 48 and 52, respectively, by an angle Ø in the preferred range of 90 to 120 degrees. In this example the angle Ø is 90 degrees, as shown in FIGS. 2 and 3 for sides 50 and 52. Sides 46 and 48, and 50 and 52 are thus configured for readily guiding the cords into the central passageways 36 and 38 since they taper towards the passageways.

The sides and central passageways of the frustoconical members are so configured to form protruding portions 54 and 56 of the frustoconical members adjacent to both the sides and passageways, as shown in FIG. 3.

The plug harness 10 includes a pair of elastic connecting bands or members 58 and 60. The connecting members 58 and 60 are preferably round in cross-section, as shown in FIG. 3. The connecting members 58 and 60 extend from and are disposed between the bevelled peripheral portions 24 and 26 of the frustoconical members 12 and 14. Advantageously, the connection members 58 and 60 as a result are partially disposed outwards and away from the frustoconical members. Thus, the bevelled peripheral portions 24 and 26 facilitate outward stretching of the connecting members 58 and 60 that may occur, for example, from a plug and socket which large than the plug 15 and socket 17 shown in FIG. 1.

The manner in which the plug harness 10 is preferably attached to the plug and socket connection 15 will now be described. Inner end 18 of the frustoconical member 14 is positioned to abut shoulder 22 of the socket 17, in this example. Next, sides 50 and 52 of frustoconical member 14 direct and guide cord 11 as it is pushed by a user's fingers towards passageway 38 which, advantageously, enables the user to perform this act without much attention or focus. As the cord 11 is pressed against the sides 50 and 52 by the user, the sides 50 and 52 are in turn caused to resiliently move outwards relative to one another. This in turn causes inner opening 47 to enlarge as to allow the cord 11 to pass therethrough and snap in place within the central passageway 38. With the cord 11 disposed within passageway 38, the force applied to the sides 50 and 52 that otherwise caused the sides to bias outwards is reduced or eliminated, enabling the sides to return to their normal, unbiased positions. This in turn causes inner opening 47 to return to its normal unbiased size shown in FIGS. 2 and 3 once more. Portions 54 and 56 of the frustoconical member 14 may abut against and frictionally engage the cord 11 so as to retain the cord within the passageway and inhibit the cord 11 from being removed therefrom.

With the inner end 18 of the frustoconical member 14 abutting shoulder 22 of the socket 17, the user may now grab onto frustoconical member 12 and pull it away from frustroconical member 14. This in turn causes connecting members 58 and 60 to stretch and expand in length. The user so stretches the plug harness as to pull frustoconical member 14 over the plug 15 such that inner end 16 of the frustoconical member 14 abuts and resiliently biases against shoulder 20 of plug 15. The user may then snap frustoconical member 14 onto electrical cord 13 in a like manner as described above for frustoconical member 12 and cord 11.

With the cords 11 and 13 so held in place by the frustoconical members, the connecting members 58 and 60 continue to be in a stretched state. Inner ends 16 and 18 thus continue to abut with and resilient bias against, or squeeze together, shoulders 20 and 22 of the plug and socket. This ensures that the plug and socket connection 19 is maintained. Put another way, this stretching of the frustoconical members 12 and 14 around connection 19 results in the device acting as a harness, retaining the plug and socket connection 19 together by applying pressure on the outside ends or shoulders 27 and 29 of the plug 31 and socket 33, respectively. Advantageously this harnessing is achieved without pulling on the electrical cords 11 and 13 themselves.

The attachment of the plug harness 10 to cords 11 and 13 and around connection 19 may be achieved in a matter of mere seconds. Attachment time is even further reduced when one is able to leave the plug harness 10 attached to one of the cords, usually the extension cord when the plug and socket are disconnected.

Many further advantages result from the structure of the plug harness 10 as herein described. For example, the structure of the present invention, with its quadrant-shaped channel, allows electrical cords to more readily and easily be guided to and received in the frustoconical members of the plug harness. The channels 42 and 44 so shaped conveniently allow the user to snap the device onto the electrical cords. Because outer openings 45 are larger than the cross-sectional diameters of the cords and inner openings 47 are smaller than the cross-sectional diameters of the cords, the sides of frustoconical members thus are shaped to both readily receive and direct the cords through the outer openings and selectively enable the cords to snap past the inner openings and into the passageways as desired, with the portions of the frustoconical members surrounding the inner openings further functioning to ensure that the cords remain in place. The channels 42 and 44 and surrounding portions of the frustoconical members thus provide a synergy of enabling the plug harness to both readily receive and also readily attach to electrical cords.

The plug harness is a useful tool for people who use electrical extension cords regularly. Connection retaining pressure is applied to shoulders 20 and 22 of plug 15 and socket 17 so that there is no stress on the electrical cords 11 and 13. The plug harness 10 does not require any tools to apply it and is quickly applied by hand to harness, deflect and maintain the electrical plug and socket connection 19 when the cords 11 and 13 are pulled or dragged in either direction. It may easily be applied in seconds. The plug harness will harness an extra-large plug and socket connection like the replacement variety.

With its round, streamlined connecting members 58 and 60 and the compact nature and frustoconical members 12 and 14, the plug harness 10 provides the advantage of smoothly deflecting the plug and socket connection 19 around or over corners and snags when the cords 11 and 13 are dragged or pulled such as when operating power tools, while effectively retaining the electrical plug and socket connection 19. Plugs getting caught or snagged can be extremely dangerous and damaging, for example when operating a skill saw, snagging can cause the blade to twist in the cut and the saw to jump and travel dangerously out of control. This can result in serious personal injury and expensive material damage. Because the connecting members 58 and 60 are round in cross-section, the cooling of the connecting members is more uniform, ensuring that there is better molecular bonding within the connecting members, ensuring that the elastic properties of the members are more uniform and thus stronger, more durable and long-lasting.

The device preferably has only two connecting members 58 and 60. This provides the important advantage of allowing the device to be molded more easily. It also reduces parts.

Because the plug harness 10 is made of an elastic, flexible material, with no rigid parts to break or slide when impacted or stepped on, the plug harness has the ability to both stretch and absorb shock. Put another way, the plug harness is configured to be non-slip when stepped on and absorbs shock when kicked. Thus, the user is less likely to trip on the plug harness or trip on the attached cords. Also, the resilience of the plug harness means that the plug harness does not distort or misshape conductor cords by crimping, wedging, bending or pressure.

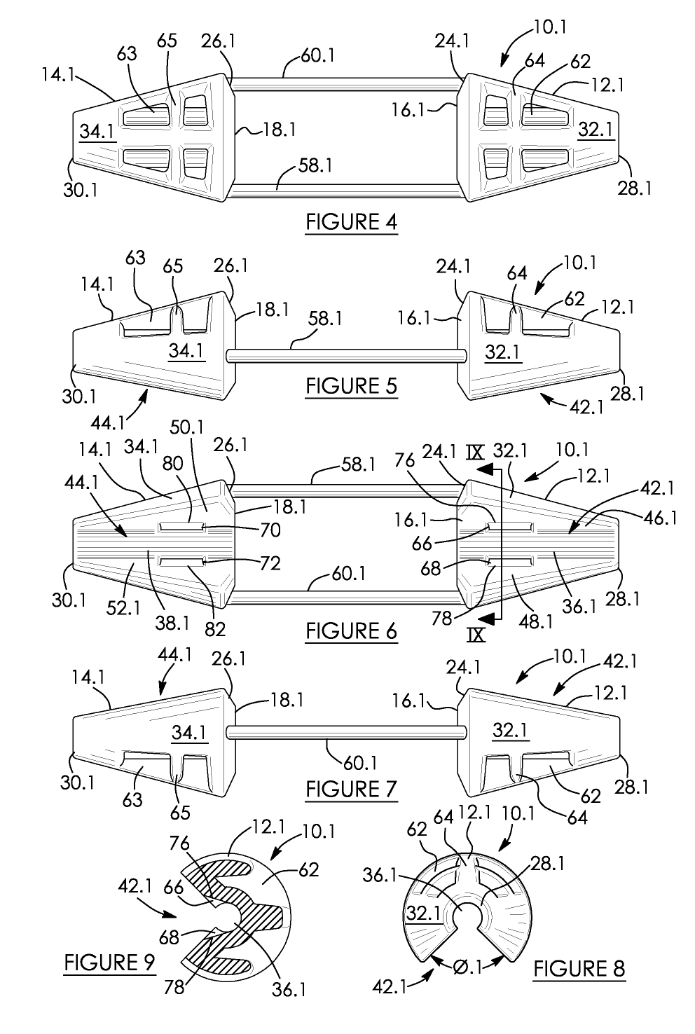

FIGS. 4 to 9 show a plug harness 10.1 according to a further embodiment. Like parts have like numbers and function as the first embodiment above with the addition of “0.1”. The plug harness 10.1 shown in FIGS. 4 to 9 is substantially similar to that shown in FIGS. 1 to 3. However harness 10.1 has exterior openings 62 and 63 and ribs 64 and 65 best shown in FIG. 4 and recesses 66 and 68 and 70 and 72 best shown in FIGS. 6 and 9.

Referring first to FIG. 4, plug harness 10.1 includes a plurality of openings 62 and 63 disposed along tapered exterior surfaces 32.1 and 34.1 of the plug harness. Openings 62 and 63 extend inwards from the surfaces 32.1 and 34.1 and are configured to promote uniform cooling of the plug harness after it is molded and inhibits deformity/bulging that may otherwise arise. Ribs 64 and 65 are interposed between openings 62 and 63 to increase and maintain the structural integrity of the frustoconical members having such openings.

Referring to FIGS. 6 and 9, frustoconical member 12.1 has a pair of spaced-apart opposed recesses 66 and 68 located between its inner end 16.1 and outer end 28.1. Recesses 66 and 68 are in communication with passageway 36.1 and at least partially extend through sides 46.1 and 48.1 of the member 12.1, as shown in FIG. 6. Each of the recesses 66 and 68 is in the shape of a triangular prism in this example.

Frustoconical member 12.1 includes a pair of spaced-apart inner walls 76 and 78 adjacent to respective ones of the recesses 66 and 68. As best shown in FIG. 9, the walls 76 and 78 are in communication with and extend tangential to passageway 36.1.

Referring to FIG. 6, recesses 70 and 72 and inner walls 80 and 82 of frustoconical member 14.1 are substantially the same as those for frustoconical member 12.1 and therefore will not be described further.

Recesses 66, 68, 70 and 72 are advantageously shaped and positioned to facilitate insertion of an initial portion of a cord into passageways 36.1 and 38.1. The initial portion of the cord may be pushed through the recesses and into the passageways via the application of a user's thumb applying force against the cord. Subsequent portions of the cord are caused to engage the passageways 36.1 and 38.1 at a non-perpendicular angle. This allows the cord to be incrementally inserted within the passageways with a fraction of the force otherwise required to insert the cord within the passageway all at once. Recesses 66, 68, 70 and 72 thus thereby act to further facilitate the insertion of the cords into the passageways 36.1 and 38.1. The recesses as herein described thus further enhance the usability of the device, acting to make it even easier to apply the plug harness to the cords.

According to one example of plug harness 10.1, connecting members 58.1 and 60.1 each have a diameter of 0.143 inches. The distance between inner ends 16.1 and 18.1 is 2.25 inches. Inner ends 16.1 and 18.1 each have a diameter of 1.313 inches. The passageways 36.1 and 38.1 each have a diameter of 0.3125 inches. The distance between outer ends 28.1 and 30.1 is 5.5 inches.

Many further variations are possible within the scope of the invention. For example the configuration of the frustoconical members 12 and 14 can vary. For example, the frustoconical members 12 and 14 may include further reliefs or a skeletal shape to save on elastic material or vary strength. Also it should be known that either frustoconical member 12 or frustoconical member 14 could be replaced by an attached socket or vary as long as one frustoconical member is the same as frustoconical member 12 or frustoconical member 14.

It will be understood by someone skilled in the art that many of the details provided above are by way of example only and are not intended to limit the scope of the invention which is to be determined with reference to the following claims.

What is claimed is:

1. A device used to maintain a plug and socket connection between two electrical cords, the device comprising:
a pair of spaced-apart frustoconical members, each said frustoconical member being in the shape of a truncated, partial cone and having an inner end, an outer end spaced-apart from the inner end, the outer end being smaller in cross-section relative to the inner end, a tapered exterior surface that extends between the inner end and the outer end, a central passageway for receiving a corresponding one of the cords, the passageway extending from the inner end to the outer end, and a pair of sides configured for guiding said one of the cords to the central passageway, each of the sides extending from the tapered exterior surface to the central passageway, the sides being angularly spaced-apart with respect to each other by an angle between 90 and 120 degrees, forming a channel therebetween; and
a pair of elastic connecting members extending from and being disposed between the inner ends of the frustoconical members, the connecting members being configured to stretch over the plug and socket and bias the inner ends of the frustoconical members against exterior ends of the plug and socket, the device thereby maintaining the plug and socket connection.

2. The device as claimed in claim 1 wherein each said frustoconical member has an inner opening interposed between the sides that is adjacent to and in communication with the central passageway, the inner openings being smaller in cross-section than the central passageways, and whereby, in order to dispose the cords within the central passageways, the sides of the frustoconical members are configured to resiliently move outwards apart, and the inner openings are configured to enlarge thereby, to allow the cords to pass therethrough and then snap in place within the central passageways, the sides resiliently coming together to retain the cords thereafter.

3. The device as claimed in claim 1 wherein the tapered exterior surface of one of the frustoconical members is straight in the direction extending from the inner end of said one of the frustoconical members to the outer end of the said one of the frustoconical members and the tapered exterior surface of the other of the frustoconical members is straight in the direction extending from the inner end of said other of the frustoconical members to the outer end of the said other of the frustoconical members.

4. The device as claimed in claim 1 wherein each said frustoconical member further has a pair of spaced-apart, opposed recesses with a space therebetween, the recesses and the space being configured to facilitate insertion of the cord.

5. The device as claimed in claim 4, wherein the pairs of recesses are disposed between the inner ends and the outer ends, respectively, of the frustoconical members, are in communication with and extend from the central passageways, respectively, of the frustoconical members, are adjacent to and extend through the pairs of sides, respectively, of the frustoconical members, and are configured for receiving therethrough initial portions of the cords for insertion into the central passageways, thereby causing remaining portions of the cords to engage with and move between the pairs of sides, and into the passageways at angles relative to the passageways.

6. The device as claimed in claim 4 wherein the sides and the recesses of the frustoconical members are shaped to enable a user to push the cords past the recesses and into the passageways via the user's thumb.

7. The device as claimed in claim 1 wherein each said frustoconical member further has a pair of spaced-apart, opposed recesses disposed between its inner end and its outer end, the recesses being in communication with its central passageway, and at least partially extending through its sides, the recesses being shaped to facilitate insertion of an initial portion of the cord into the central passageways.

8. The device as claimed in claim 7 wherein each said frustoconical member further has a pair of spaced-apart inner walls adjacent to respective ones of the recesses, the inner walls being in communication with and extending tangential to the central passageways and extending to the sides.

9. The device as claimed in claim 6 wherein each of the recesses is in the shape of a triangular prism.

10. The device as claimed in claim 1 wherein each said frustoconical member has an outer opening adjacent to its sides which is larger than the cross-sectional diameter of its respective passageway and has an inner opening adjacent to its respective passageway and its sides, the inner openings being smaller than the cross-sectional diameters of the passageways.

11. The device as claimed in claim 1 wherein each said inner end of the frustoconical members has a bevelled peripheral portion disposed to face at least partially outwards from the device, the bevelled peripheral portions being configured to inhibit the inner ends of the frustoconical members from getting caught on objects.

12. The device as claimed in claim 1 wherein each inner end of the frustoconical members has a bevelled peripheral portion disposed to face at least partially outwards from the device, the connecting members extending from and being disposed between the bevelled peripheral portions, the bevelled peripheral portions thus facilitating outward stretching of the connecting members caused by a plug and socket interposed therebetween.

13. The device as claimed in claim 1 wherein the outer ends are relatively flexible compared to the inner ends, the outer ends thus being configured to accommodate bending and deflections of portions of the cords adjacent thereto while the inner ends maintain the plug and socket connection.

14. The device as claimed in claim 1 wherein the connecting members are round in cross-section.

15. The device as claimed in claim 1 wherein the device is made of an elastic material.

16. The device as claimed in claim 1 wherein the device is a one-piece molded device made of flexible elastic material.

17. The device as claimed in claim 1 wherein the passageways are partially cylindrical in shape.

18. A device used to maintain a plug and socket connection between two electrical cords, the device comprising:
a pair of spaced-apart frustoconical members, each said frustoconical member having an inner end, an outer end spaced-apart from the inner end, the outer end being smaller in cross-section relative to the inner end, a tapered exterior surface that extends between the inner end and the outer end, a central passageway for receiving a corresponding one of the cords, the passageway extending from the inner end to the outer end, a longitudinal channel configured for guiding said one of the cords to the central passageway, the longitudinal channel extending from the tapered exterior surface to the central passageway, and a pair of spaced-apart, opposed inner walls defining a space therebetween to facilitate insertion of the cord into the central passageway, the inner walls being disposed between the inner end and the outer end, each extending from a respective side of the central passageway to the channel and being spaced-apart from each other at a distance equal to or greater than the cross-sectional diameter of the passageway; and
a pair of elastic connecting members extending from and disposed between the inner ends of the frustoconical members,
whereby the connecting members are configured to stretch over the plug and socket, thereby biasing the inner ends of the frustoconical members against exterior ends of the plug and socket for maintaining the plug and socket connection.

19. The device as claimed in claim 18, wherein the inner walls extend tangentially from the central passageways.

20. A device used to maintain a plug and socket connection between two electrical cords, the device being made of an elastic material and comprising:
a pair of spaced-apart frustoconical members, each said frustoconical member being in the shape of a truncated, partial cone and having an inner end, the inner end including a bevelled peripheral portion disposed to face at least partially outwards from the device, the bevelled peripheral portion being configured to inhibit the inner end from getting caught on objects, an outer end spaced-apart from the inner end, the outer end being smaller in cross-section relative to the inner end and the outer end being relatively flexible compared to the inner end to accommodate bending and deflection of portions of the cords adjacent thereto, a tapered exterior surface that extends between the inner end and the outer end, the tapered exterior surface being straight in the direction extending from the inner end to the outer end, a central passageway for receiving a corresponding one of the cords, the passageway extending from the inner end to the outer end, a longitudinal channel configured for guiding said one of the cords to the central passageway, the channel being quadrant-shaped in cross-section, and a pair of spaced-apart, opposed recesses and inner walls configured for facilitating disposal of an initial portion of the cord into the central passageway, wherein the recesses are disposed between the inner end and the outer end, are in communication with opposite sides of the central passageway, and at least partially extend through portions of the frustoconical member surrounding the channel, each recess being in the shape of a triangular prism, and wherein each inner wall is adjacent to a respective one of the recesses and tangentially extends from the central passageway to the channel; and
a pair of elastic connecting members extending from and being disposed between the bevelled peripheral portions of the inner ends of the frustoconical members, the connecting members being round in cross-section and the bevelled peripheral portions being disposed to facilitate outward stretching of the connecting members,
whereby the connecting members are configured to stretch over the plug and socket, thereby biasing the inner ends of the frustoconical members against exterior ends of the plug and socket for maintaining the plug and socket connection.
